(19) United States
(12) Patent Application Publication
(10) Pub. No.: US 2012/0011041 A1
(43) Pub. Date: Jan. 12, 2012

(54) POST BANKRUPTCY PATTERN AND TRANSACTION DETECTION AND RECOVERY APPARATUS AND METHOD

(76) Inventors: Michael L. Beydler, Mission Viejo, CA (US); Daive K. Beydler, Alhambra, CA (US)

(21) Appl. No.: 13/177,154

(22) Filed: Jul. 6, 2011

Related U.S. Application Data
(60) Provisional application No. 61/361,594, filed on Jul. 6, 2010.
(60) Provisional application No. 61/361,599, filed on Jul. 6, 2010.

(51) Int. Cl. G06Q 40/00

(52) U.S. Cl. 705/35

(57) ABSTRACT

A method for post bankruptcy recovery of a consumer with an outstanding credit card balance is disclosed. The method includes the steps of scoring a portion of a related set of consumer transactions and received payments in accordance with an item set criteria to determine a level of collectability, weighting the portion of the related set of consumer transactions in accordance with age of data and in accordance with external consultant assessments and recommendations based on consumer financial status, and comparing at least one portion of a transaction description from the related set of consumer transactions to historical data from transaction descriptions to update and adjust the level of collectability.

### PRIORITY AND RELATED APPLICATION(S)

This non-provisional U.S. utility patent application is a co-pending application to U.S. non-provisional application Ser. No. ______ “PRE-BANKRUPTCY PATTERN AND TRANSACTION DETECTION AND RECOVERY APPARATUS AND METHOD”, which application is incorporated by reference in its entirety, and this non-provisional U.S. utility patent application further incorporates by reference in its entirety and claims priority to U.S. provisional patent applications entitled “PRE-BANKRUPTCY FRAUD DETECTION APPARATUS AND METHOD” Ser. No. 61/361,594 filed on Jul. 6, 2010, AND “POST BANKRUPTCY FRAUD DETECTION APPARATUS AND METHOD” Ser. No. 61/361,599 filed on Jul. 6, 2010, both with the same inventors as herein application.

### BACKGROUND OF THE INVENTION

1. Field of the Invention

The invention relates generally to the field of financial data processing systems, and specifically in one exemplary aspect to lender scoring systems employing post bankruptcy detection of credit card transactions for consumers and modeling thereof.

2. Description of Related Technology

Financial data processes, both apparatuses and methodologies, are well known in the art. Financial data processing, such as related to lender profiling, lender behavior analysis and modeling, for instance as it relates to rating lenders based on data derived from their respective consumers are disclosed in representative US Patent Publication 2009/0248573, which is herein incorporated by reference in its entirety. Another methodology is disclosed in representative US patent publication 2009/02344683, which is herein incorporated by reference in its entirety, determines a risk of transaction by conversion of high categorical information, such as text data, to low categorical information, such as a category or cluster IDs.

Still other representative financial data processes, such as disclosed in US Patent Publication(s) US 2009/0222380, US 2009/0048966, US 2008/0255951, US 2008/0222027, US 2007/0288360, US 2007/0011083, US 2006/0226216, and US 2006/0212366, which are all herein incorporated by reference in their entireties, utilize one or more techniques. These methods include providing a seller an irrevocable method of receiving funds, generating excess funds using a credit instrument, and utilizing various data sources to provide outputs to describe consumers spending behavior. The methods further include matching an applicant with a position grade based on credit information, processing of asset financing transactions, and providing risk data, e.g., based on a denial rule set, to an entity engaged in a transaction with a consumer.

Yet other representative financial transaction processes, such as those disclosed in U.S. Pat. No. 7,567,934, U.S. Pat. No. 7,546,271, U.S. Pat. No. 7,403,922, U.S. Pat. No. 7,376,618, and U.S. Pat. No. 7,272,575 (which are herein incorporated by reference in their entireties) are specific hardware/software implementation(s) that utilize one or more techniques to prevent or reduce potential fraudulent usage thereof. Some of these techniques include limit use of card number, provide remote access devices for accessing a limited use credit card number, and detect inconsistencies in one or more data fields from a plurality of database records. Still other techniques include match of records using highly predictive artificial intelligence patterns, data mining to convert high categorical information to low categorical information to generate a level of risk of a particular transaction, and develop Complete Context.TM.Bots for an organization.

Yet other financial transaction processes, such as those disclosed in U.S. Pat. No. 7,263,506, U.S. Pat. No. 7,039,654, U.S. Pat. No. 6,999,943, U.S. Pat. No. 6,785,592, U.S. Pat. No. 6,658,393, and U.S. Pat. No. 5,732,400 (which are herein incorporated by reference in their entireties) disclose specific hardware/software implementation(s) to prevent or reduce potential fraudulent usage. These hardware/software usage include offering multiple payment methods to improve user profitability by directing profitable transactions to participating issuers, generate a predictive model based on historical data, and request current transaction authorization through one or more sources.

Thus, what are needed are improved financial processing processes and apparatuses that permit easy initial configuring and reconfiguring, i.e., multiple adaptive learning and neural network modeling algorithms, to improve real-time detection of fraudulent transactions and recovery of consumer lending credit, which minimizes the required labor and/or time and increases overall recovery values. Such improved apparatus and methods would also ideally minimize labor-intensive tasks of adjustment and/or installation of algorithms and structures. Furthermore, it would be advantageous for the improved process or system to provide multiple configurations, and thus permit the creation of user-customized consumer credit collection recovery configurations using one or more structures or components and software routines. In addition, the improved process or system would assist in recovery of delinquent consumer credit and thereby potentially reduce a number or magnitude thereof of consumer financial credit write-offs by a lender, such as a financial institute, banking association, or credit card issuer.

### SUMMARY OF THE INVENTION

In one aspect of the present invention, a credit card debt recovery system (system) is disclosed. More specifically, a consumer credit card debt collection recovery system recovers money from fraudulent credit card charging following issuance of credit to account holder(s). In one embodiment, the credit card debt collection recovery system includes a multitude of adaptive learning and neural network modeling algorithms to detect fraudulent credit card charging based on a detection of data transactions in one of several fraud elemental categories. In one variant, a comprehensive financial risk credit report grades an indication of fraud and provides a real-time indication of whether debt recovery is feasible.

In one aspect, a method is disclosed for post bankruptcy recovery of a consumer with an outstanding credit card balance. In this method, a portion of a related set of consumer transactions and received payments is scored in accordance with item set criteria to determine a level of collectability. The portion of the related set of consumer transactions is weighted in accordance with age of data and in accordance with external consultant assessments and recommendations based on consumer financial status. One or more portions of a transaction description from the related set of consumer transactions is compared to historical data from transaction descriptions to update and adjust the level of collectability.

In one variant, a partial word search is executed from one or more transaction descriptions with one or more product databases to at least partially identify if a product or service from the set of consumer transactions has an associated necessity or non-necessity purpose to adjust the level of collectability. In another variant, a ratio is generated of the associated necessity to non-necessity purpose of the outstanding credit card balance to further adjust the level of collectability. In yet another variant, a debt scorecard is generated that indicates an amount qualifier that interrelates to the level of collectability of the outstanding credit card balance.

In still yet another variant, wherein the portion of the related set of consumer transactions comprises a set of consumer transactions each having an uncharacteristic purchase or spending pattern within a specified period that has not been paid back. In another variant, the uncharacteristic purchase includes at least one of a cash advance or purchase greater than $500.00.

In still another variant, the related set of consumer items comprises at least one item set selection of purchases of services or products categorized in accordance with gaming, gambling, or casino services within a specified period before the consumer files for a discharge in bankruptcy. In yet another variant, the related set of consumer transactions comprises at least one item set selection of purchases of services or products categorized in accordance with high end-hotels, car repairs, airline tickets, entertainment events, vacation packages, high end clothing stores, jewelry, and high end electronics within a specified period before the consumer files for a discharge of debts under bankruptcy.

In one variant, weighting the portion of the related set of consumer transactions in accordance with age of data comprises evaluating a first item set individually in accordance with a time grading criteria based on historical frequency of purchase of a service or product that indicates an uncharacteristic high credit card balance or a period when payback of an existing credit card balance is at a minimum payment level or less than 5% of an existing credit card balance.

In yet another aspect, a system is disclosed for post bankruptcy recovery of a consumer with an outstanding credit card balance. In one embodiment, a scoring module is operable to score a portion of a related set of consumer transactions and received payments in accordance with an item set criteria to determine a level of collectability, the related set of consumer transactions comprises at least one item set selection of purchases of services or products. In one variant, the at least one item set selection of purchases of services or products are categorized in accordance with high end-hotels, car repairs, airline tickets, entertainment events, vacation packages, high end clothing stores, jewelry, and high end electronics within a specified period before the consumer files for a discharge of debts under bankruptcy.

In another variant, a weighting module is operable to weight the portion of the related set of consumer transactions in accordance with age of data and in accordance with external consultant assessments and recommendations based on consumer financial status. In yet another variant, a comparison module is operable to compare at least one portion of a transaction description from the related set of consumer transactions to historical data from transaction descriptions to update and adjust the level of collectability. In one alternative, the historical data is chosen in accordance indicate at least one of a poor credit card payment history or high credit card balance with payments of a minimum credit card payment.

In another variant, the comparison module may be further operable to generate a ratio of the associated necessity to non-necessity purpose to further adjust the level of collectability. In one alternative, a debt scorecard module is operable to generate a debt scorecard that indicates an amount qualifier that interrelates to the level of collectability of the outstanding credit card balance. In one variant, the portion of the related set of consumer transactions comprises a set of consumer transactions having an uncharacteristic purchase or spending pattern within a specified period that has not been paid back. In yet another variant, the uncharacteristic purchase includes at least one of a cash advance or purchase greater than $500.00. In yet another variant, the related set of consumer transactions comprises at least one item set selection of purchases of services or products categorized in accordance with gaming, gambling, or casino services within a specified period before the consumer files for debt relief under bankruptcy.

In another aspect, a method is disclosed for assistance in generation of objective evidence of an outstanding credit card balance in a post-bankruptcy setting. The method may include the step of scoring a portion of a related set of consumer transactions and received payments in accordance with an item set criteria to determine a level of collectability. The method may further include the step of weighting the portion of the related set of consumer transactions in accordance with age of data and in accordance with external consultant assessments and recommendations based on consumer financial status; wherein a first item set is evaluated individually in accordance with a time grading criteria based on historical frequency of purchase of a service or product that indicates an uncharacteristic high credit card balance or a period when payback of an existing credit card balance is at a minimum payment level or less than 5% of the existing credit card balance.

In one variant, the method includes the step of comparing at least one portion of a transaction description from the related set of consumer transactions to historical data from transaction descriptions to update and adjust the level of collectability. In another variant, the method includes the step of executing partial word search from the one or more transaction descriptions with one or more product databases to at least partially identify if a product or service from the set of consumer transactions has an associated necessity or a non-necessity purpose to adjust the level of collectability. In one variant, the method may include the step of generating a ratio of the associated necessity to non-necessity purpose to further adjust the level of collectability.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a flow diagram of a post bankruptcy recovery system including pattern recognition and post-bankruptcy association rule learning in accordance with the post bankruptcy system of FIG. 1.

FIG. 2 is a flow diagram of a post bankruptcy financial processing scheme including scoring and grading credit rating for consumers in accordance the post bankruptcy system of FIG. 1.

FIG. 3 is a three-dimensional illustration of consumers grading in accordance with the post bankruptcy system of FIG. 1.

FIG. 4 is a diagram of lattice matrix used in scoring and grading credit ratings of consumers in accordance with weighting and association rules in accordance with FIG. 1.

FIG. 5 is a waveform flow chart illustrating spikes from an average value in accordance with the post bankruptcy system of FIG. 1.

FIG. 6 is a diagram of a system and apparatus utilizing the post bankruptcy system of FIG. 1.

FIG. 7 is a diagram that illustrates the post bankruptcy association rule algorithm and post bankruptcy association learning rule algorithm process flow of FIGS. 1-3.

FIG. 8 is a composite credit report of the post bankruptcy recovery system of FIG. 1.

FIG. 9 is a consumer credit report generated from the post bankruptcy financial processing scheme of FIG. 2 including scoring, grading credit rating, and rationale for grade per consumer for sending to attorney for evaluation in accordance with the post bankruptcy system of FIG. 1.

FIG. 10 is a credit card company generated report that illustrates amount of money recovered on a weekly and a monthly basis in accordance with scorecard reporting of the post bankruptcy recovery system of FIG. 1.

FIG. 11 is a flow chart illustrating the processing of a post-bankruptcy case in accordance with FIG. 1.

### DETAILED DESCRIPTION

Reference is now made to the drawings wherein like numerals refer to like parts throughout.

### Overview

In one salient aspect, the present invention discloses apparatuses and methods for detecting recoverable and non-recoverable consumer transactions related to, inter alia, lender sources including credit card institutional lenders. In particular, the present invention discloses an apparatus and method that may be configured to assist a lender or financial institution in evaluation of transactions (e.g., non-recoverable, recoverable, potentially fraudulent, and fraudulent) and a method for initiating collection proceedings against consumer credit card debtors. Furthermore, the present invention further discloses a technique for accurately portraying in real-time, incidents of non-recoverable, recoverable and fraudulent credit transactions identified, such as, luxury items that have been recently purchased, for instance, in a 90 day window before declaration of bankruptcy. In addition, the present invention collects empirical data associated with groups of credit card debtors in a convenient database, with selected financial information highlighted in a non-distracting manner to assist or ease identification of non-recoverable and recoverable transactions.

In addition, the system, method, and apparatus of this invention advantageously provides a more intuitive methodology to view credit scoring of consumer transactions in real-time situations where human review and operations management cannot detect recoverable, e.g., fraudulent, until months after the transaction has been completed. For instance, a user with the principles of this invention in real-time obtains a recovery report that identifies recoverable, non-recoverable, and fraudulent transactions and distinguishes physical and empirical characteristics of the transactions. The physical and empirical characteristic may include any or all the following: bankruptcy associative elements (from the incorporated by reference application), specified period for reporting, bankruptcy court case status, time averaging during specified period for reporting, and as related to “real-time” transaction data to current consumer debt rating in an easy to follow manner. As such, this thereby allows a user's brain to more intuitively distinguish signals of past and current financial delinquency details as related to federal, state, or local bankruptcy laws, even when there are one or more credit card invoices that are delinquent or overdue.

In addition, the apparatus advantageously provides the ability to preserve database information of the different sources and attaches and adjusts indicators and details of transactions into a more natural format and into a single credit card bankruptcy report.

Advantageously, in one embodiment, database algorithm(s) improves the detection of consumer fraudulent transactions when purchasing from merchants that are of a different type or kind thereof from that of the historical transactions (for example purported purchase of expensive luxury car, e.g., Porsche sport car, exotic cruise ship passage, rare and expensive perfumes, silk, antiques, collectibles, etc.).

Advantageously, the system improves a user's ability to distinguish details of transactions and other finer features that could not otherwise be seen using conventional financial programming software or apparatus, such as credit checks. Furthermore, one or more data mining routines of one embodiment unobtrusively highlights objective evidence of potentially recoverable or fraudulent transaction information for collection agencies to utilize in evaluating likelihood or probability of successful credit card collection debt efforts. In addition, the principles of these embodiments can be part of a post bankruptcy assist program or service tool that will aid in the detection of recoverable consumer transactions.

### Exemplary Apparatus, Methodology, and System

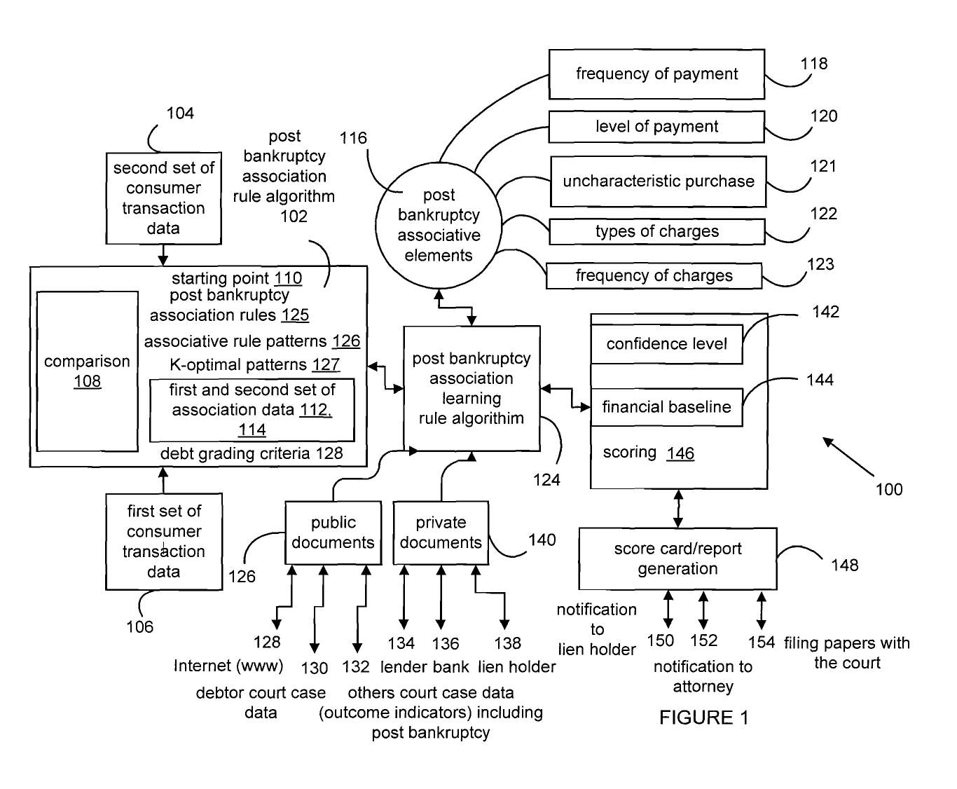

Referring to FIGS. 1-11, exemplary embodiments of the apparatus, system, and methods of the invention are described in detail. It will be appreciated that while described primarily in the context of a consumer credit card fraud recovery system and apparatus, e.g., the system detects credit card fraud and recovers uncollected credit card billings for post bankruptcy cases based on post bankruptcy associative elements, consumer history, transactional type, frequency of transactions, timing of transactions. In addition, there are at least portions of the apparatus and other methodology for configuring the apparatus described herein that may be used in other applications or purposes.

For example, it will be recognized that the present invention may used to create consumer credit payment models and credit coding charts that indicate credit history and probability of timely future payments. Other functionality or applications of the present invention may include assistance in clearance processing of retail and commercial credit card application(s), determination of type and line of credit to provide a prospective consumer, security monitoring of present consumer credit card transactions, car dealership loan application processing and clearance processing, and the like. The functionality or applications of the present invention may also be applied to the discovery of invalid, high-risk, characteristic, uncharacteristic, or likely fraudulent transactions in industries other than the financial industry, such as healthcare. As such, a myriad other functions will be recognized by those of ordinary skill given the present disclosure.

Referring to FIG. 1, Post Bankruptcy Fraud Detection (PBFD) system 100 (system) includes the following: financial transactions scoring, weighting financial transactions age, historical data slider, linear comparison sub-tables, and amount qualifier. In one embodiment, financial transactions scoring evaluate financial line transactions in accordance to rate grading system (e.g., highest level of recovery or likely hood of fraud to lowest level of fraud). In variant, system 100 evaluates financial line transactions and provides a transaction rating (grade) from A (very likely to win in court) to F (least likely to win in court).

In one variant, system 100 derives a grade by evaluating and scanning a list of transactions from a debtor's credit card statement over specified time period (e.g., up to 180 days), while, weighting attorney assessments and viewpoints therewith. In one variant, system 100 detects a large cash advance three months prior to filing chapter 7 bankruptcy. In one alternative variant, when a debtor increases its advance payback over the 3-month period by more than 10 percent of the total amount advanced, system 100 would indicate debtor has intent to pay back the advance and would provide a rating of F and a low likelihood of potential non-payment or fraud. In one variant, system 100 diminishes or provides an indication that a risk of potential non-payment or fraud (no intent to pay) is minimal in accordance with debtor payback behavior over a specified period. Continuing with this example, if instead debtor provided a payment of 8 percent of the outstanding credit balance within the same period, system 100 provides a score of E or higher, which would be indicative of increased risk of potential non-payment or fraud. Still continuing with this example, if instead a debtor provided a payment of 2 percent of the outstanding credit balance over the same period, system 100 would most likely assign B rating (good possibility of recovery) or higher (due to an decreased payment scheme) and that the risk of potential non-payment or fraud is high.

### Starting Point Selection

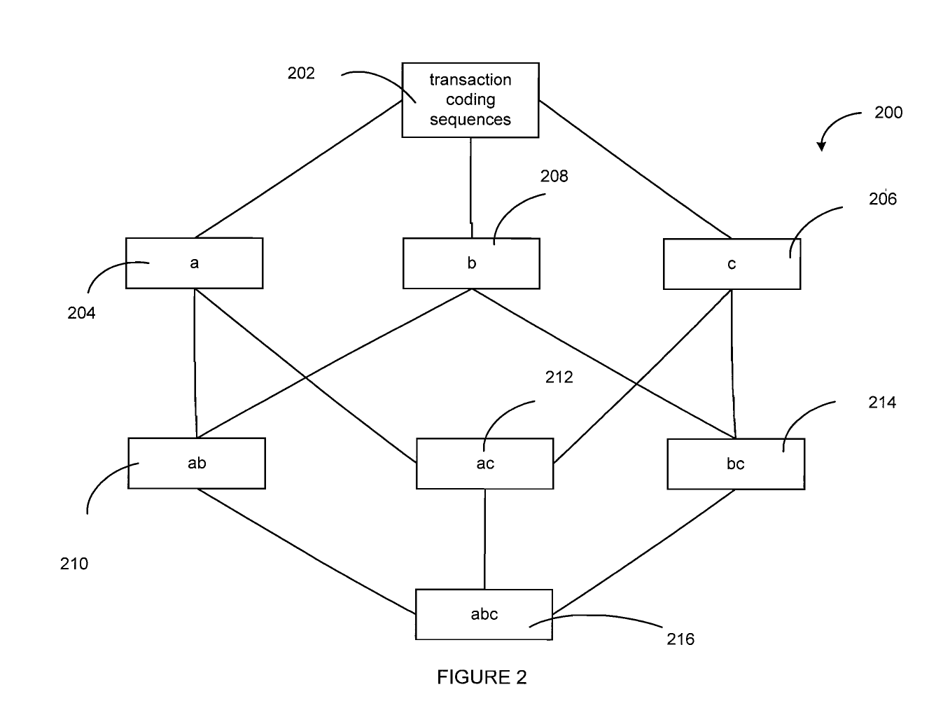

Referring to FIG. 2, during comparison 108, first and second set of association data 112, 114 purchases and payment information are cross-referenced against post bankruptcy associative elements 116. In one embodiment, the first set of association data 112 are chosen within a 180 day window of declaration of bankruptcy. In yet another embodiment, the first set of association data 112 are chosen with a 90 day window of declaration of debt relief under bankruptcy. In one embodiment, starting point 110 for selecting transaction history for populating first or second set of consumer transaction data 104, 106 may begin with an uncharacteristic purchase or transaction. In one variant, an uncharacteristic purchase of services or products or transactions that may include consumer cash advances (as discussed supra) and/or consumer purchasing a new yacht, luxury automobile, classic automobile, car repairs, airline tickets, entertainment events, vacation packages, high end clothing stores, jewelry, and high end electronics within a specified period before a consumer files for debt discharge in a bankruptcy proceeding. In yet another example, starting point 110 may be selected based on frequency of purchases (e.g., a large number or increased frequency of purchases over a short period shortly before filing bankruptcy) make these transactions to have a high level of non-dischargeability during a collection process.

In one alternative, starting point 110 may be set in accordance when an uncharacteristic increase in a consumer's daily outstanding credit card balance occurs. In one example, a consumer payment history is good at time t1; however, at time t2 (one month later) the consumer makes an uncharacteristic purchase, e.g., a yacht or new car, and never makes payments on this purchase. In one variant of this embodiment, starting point 110 can be set after the consumer's last payment date to illustrate poor credit history to increase chances of a lien or collection agency to collect on this matter (improve collection grade or scorecard on this consumer).

In another alternative, consumer transactions at starting point 110 (e.g., start date for transaction review) includes large number of non-dischargeable bankruptcy transactions of items (products) or services. For example, non-dischargeable bankruptcy transactions, even if a high amount, may not be collectible. However, purchases of luxury item such as a yacht may signal the starting point 110 for first set of consumer transaction data 106 being reselected just before purchase of luxury item to maximize probably that a court of law will allow collection of debt.

In another embodiment, starting point 110 for selecting transactional history is unique for first and second set of consumer transaction data 106, 104. In yet another variant, starting point 110 and a time window is chosen, for instance, with staggered, partially overlapping transactional history for first and second set of consumer transaction data 106, 104 and/or first and second set of association data 112, 114.

Advantageous as compared to collection agencies where a collection period is fixed, system 100 has starting point 110 that is variable for the collection process. Thus, starting point 110 being variable (variable starting point) for first set of association data 112 provides to a credit card company or lien holder a variable, that on an individual basis, is selectable and adjustable. For example, the variable starting point may be chosen to maximize a recoverable amount of non-dischargeable items on an individual item basis and where the selection process uses identified physical characteristics in a pre-bankruptcy setting of uncharacteristic transactions for collection of outstanding credit card balance. Furthermore, as compared with conventional collection agencies where highest value accounts (largest credit card balances) are pursued through the collection process upon debtor filing bankruptcy case, system 100 provides automated capability of quickly identifying non-dischargeable items on a sliding time period scale (variable starting point for first set of association data) with regard to multiple outstanding credit card accounts. Advantageous, system 100 rapidly analyzes credit card account particulars and provides objective evidence (including plots of changes) in spending patterns on a per item set basis. Furthermore, system 100 provides collectively objective evidence of non-dischargeable items on multiple item sets to a lender or credit card company real-time indicators for attorneys or other lender representatives to provide to a court or debtor after filing case to increase likelihood of collection.

Consequently, system 100 in an automated fashion quickly compares numerous consumer outstanding credit card balances with objective account criteria (bankruptcy associative elements, which will be discussed supra). Thus, system 100 capabilities provide for identification of high opportunity collection of outstanding credit card accounts before a credit card holder receives a bankruptcy decree and/or continues with a current bankruptcy filing, which filing, if successful may prevent credit card collection all together. Furthermore, use of debt grading criteria when comparison of first set of association data 106 and second set of association data to more readily identify objective elements of non-dischargeable transactions in real-time consumers. As such, debt grading criteria decreases collection scorecard for debts or non-payments beyond a specified period so that association rule algorithm 102 generates a more real-time and update scorecard profile as determined on a case by case basis in conjunction with specific point as compared to many conventional credit card rating processes.

### Post Bankruptcy Associative Elements

Referring again to FIG. 1, system 100 includes post bankruptcy associative elements 116 for a credit card transactions may include any or all the following: unique purchase 121 of product or service, frequency of payments 118, level of payment(s) 120, types of charges 122, debtor court case outcome indicators 144, and others court case outcomes 146. For example, if consumer frequency of payment 118 increases as well as level of payment 120 increases, then the post bankruptcy associative elements analysis would result in a decreased ability to collect in a bankruptcy court setting (e.g., inability to pay score and/or fraud score would be poor). In contrast, a consumer with infrequent or minimum payments on every payment period would result in an increased ability to collect in a bankruptcy court setting. In yet another example, uncharacteristic purchase 121 such as a type of charges 122 such as multiple jewelry necklace purchases with no prior purchases like this with a specified window before filing a bankruptcy case would result in an increased recovery score. Furthermore, the recovery score would be further improved if combined in conjunction with low frequency of payments 118 occurring within a specified window upon filing for bankruptcy relief.

Continuing with this embodiment, as illustrated above, starting point 110 for collection or choice of outstanding credit card accounts may be altered or changed in response to information obtained when comparison of various starting period purchases. In response of the first and second sets of consumer transaction data 106, 104, association data 112, 114 along with court case data 130 are indexed and referenced as system 100 searches for match (e.g., best match for data comparisons). For example, if court case data 130 indicates a consumer's bankruptcy filing will be denied or has inconsistencies, then this information can be used during scoring processing of the debt. Furthermore unfinished or pending court indicators (e.g., preliminary court rulings, record of the court's minutes) may help as well identify other credit card purchases which are similarly requested to be discharged to further solidify a pattern for collection of credit card debt. In addition, others court case data 132 including relatives, family members, as well as debtor's company debt as well as account receivables information hold relevancies that may assist creating associations to generate a consumer credit prediction model or one or more associative rule patterns 126 to increase or decrease likelihood (increase or decrease scorecard value) of collecting from consumer or others after filing a bankruptcy relief proceeding or consumer requests debt relief under bankruptcy. In one variant, post bankruptcy association leaning rule algorithm utilizes public 126 and private 140 documents from debtor and others cases to further redefine/define post bankruptcy association rule algorithm 102 and post bankruptcy associative elements 116.

For example, post bankruptcy associative elements 116 used in conjunction with post bankruptcy data including others court case data being utilized to form a post bankruptcy association rule learning algorithm 124. For instance, system 100 uses association rule algorithm 102 to identify groups of post bankruptcy associative elements 116 (e.g., for a specified time period, a debtor increases purchasing of TVs, couches, etc. while decreasing credit card payments). These purchases create associations within system 100 and can be utilized to generate credit worthiness predictions based on matching with others cases that have generated chapter 7 bankruptcies or are pending before the chapter 7 bankruptcies court.

### Consumer Spending Patterns

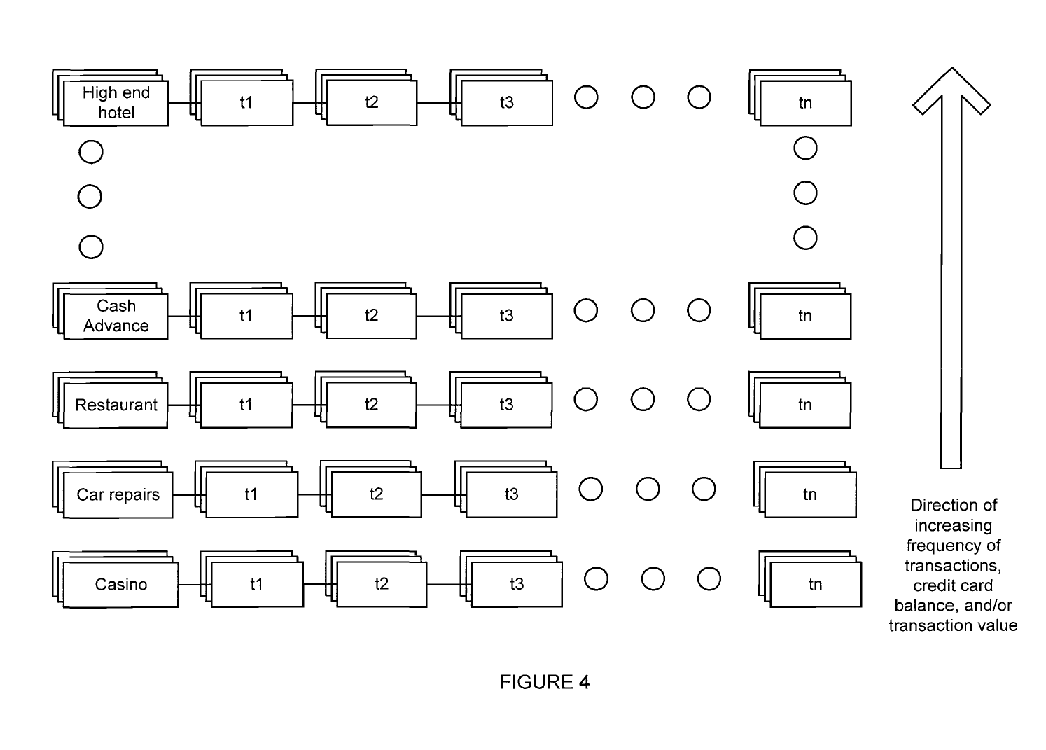

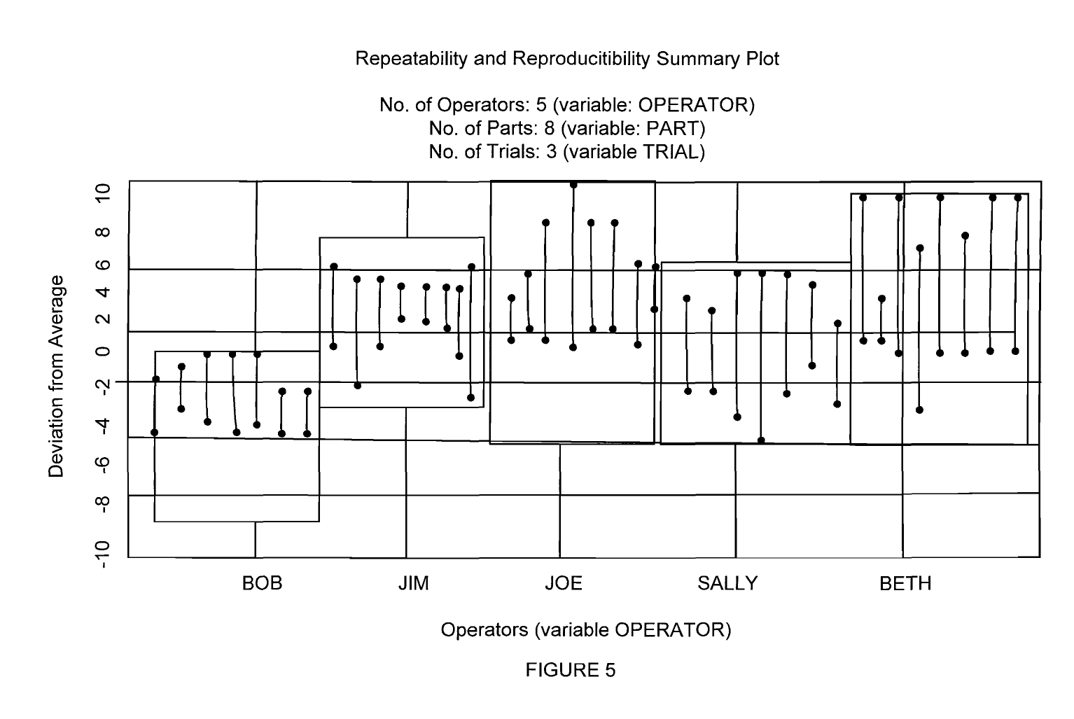

Referring to FIG. 1, supplemental financial data for X and Y are compared for current period (tm) looking backwards until uncharacteristic financial transaction item (i.e., uncharacteristic purchase 121 of product or service) has been located (e.g., a $5,000 cash advance, balance transfer, or the like type of payment behavior). Using this uncharacteristic financial transaction item (i.e., uncharacteristic purchase 121 of product or service) system 100 determines starting point 110 for non-dischargeable transactions and/or additional information may be required to determine if there are non-dischargeable items and to build a case against the debtor to recover non-dischargeable transactions. In one exemplary embodiment, consumer spending patterns (associative rule patterns 126) are analyzed by converting linear transaction amounts into waveform over a specified time delta (see FIG. 5). In one variant, consumer-spending patterns include types of purchases along with variables of, for instance, time aging of purchases and purchase repetitiveness that are included as part of debt grading criteria. In one example, waveform data is averaged and represented as baseline credit pattern for the array (e.g., 0 in FIG. 4). Purchase ripples (e.g. spikes in FIG. 5) that stand out (e.g., spikes that are created by repeat spending patterns) from baseline credit patterns are tagged and matched as closely as possible recovery items in a post bankruptcy setting. Referring to FIG. 5, spikes that are above 0 represent an increasing level of credit card balance for a given item set and spikes that are below 0 represent a decreasing level of credit card balance for a given item set. For each consumer, an average of these spikes give a scorecard rating that determines grade (A through F) as well as likelihood of successful collection processing.

In one embodiment, post bankruptcy association rules 125 determine and satisfy a minimum support level (e.g., a financial baseline 144 for a consumer transaction to determine average spending or balance for an item set) and a minimum confidence level (e.g., confidence level 142 is an index to determine if a consumer transaction is non-dischargeable or fraudulent). In one embodiment, scoring of post bankruptcy (e.g., chapter 7) with individual debtors is reviewed in accordance with probability factoring. Following, system 100 generates a scorecard. In one example, a scorecard indicates a scoring percentage based upon, for instance, formation and derivates of outputs based in part on minimum support level and confidence level. In one variant, minimum support level applies to all, one, or more groups of frequent item sets in a database.

### Association Rules

Referring to FIG. 2, frequent item sets and minimum confidence constraints are utilized to create association rules. In one embodiment, numerous frequent item sets are chosen from one or more databases (e.g., financial data source(s), public database(s), commercial database(s) or the like) by searching one or more item sets (e.g., item combinations). Advantageously, as compared to conventional debt collection or fraud detection systems, system 100 in real-time derives and modifies its association rules (or table thereof) based on complete or partial data contained in item sets.

Continuing with this embodiment, system 100 post bankruptcy association rules are derived from one or more item sets. In one variant, a first item set may be a head (first part of an association rule) and second item set may be a body (second part of an association rule). In one variant, head and body may represent simple codes, text values (items), and/or conjunction of codes and text values. In one exemplary embodiment, first item set 210 includes Car=Porsche and Age<20 (ab in FIG. 2) and second item set 212 includes Risk=High and Insurance=High (ac in FIG. 2). Continuing with this embodiment, system 100 would assign a logical connection between first item set being body and second item set being head to form an association rule 216 (abc in FIG. 2) utilized to evaluate sets of association data 106, 104 as part of comparison 108 process.

Post bankruptcy association rules 125 identify associations (e.g., regularities) between one or more item sets (e.g., item sets 210, 212, 214) that are supplemental information for first and second set of consumer transaction data 106, 104. Post bankruptcy association rules 125 generated in real-time assist in creation of improved accuracy representations of consumer's current financial status (real time snapshot of a consumer's spending patterns). In contrast, conventional credit check services use of historical data (credit check information), which information or data may be at best weeks or months old and each of the transactions merely identified by, for instance, business owner code or name, which may not represent a true type or category of the consumer's purchase. Thus, these identified transactions may be mis-identified as dischargeable items (thus not subject to discharge by a court) and not represent to a creditor a consumer's real-time pre-bankruptcy financial status. Advantageously, system 100 provides continuous, real-time analysis of transactions for bankruptcy debtor filings and associates completed transaction association snapshots with bankruptcy data trends within, for instance, a 90 day or 180 day window, to find relevancies. Furthermore, post bankruptcy association rules 125 are real-time graded.

Referring again to FIG. 2, transaction rating (grade) system 100 evaluates financial line transaction in accordance with type of transaction (e.g., SIC code value). In one variant, system 100 segments one or more of financial line transactions and uniquely grades purchases. In one variant, one or more financial line transactions are unique graded against a constantly updated descriptor database. For instance, system 100 may have database 210 that assigns A rating (high possibility of recovery) for transaction with the describer “strip joints”. In another variant, bank transaction may be segmented into fields including SIC, amount of transaction, date of transaction, and description of transaction. In yet another variant, partial words within a transaction description are extracted (e.g., phone number, block text prior to LLC text, coded alpha-numeric information designating consumer identity, commercial business, and the like) and compared to system 100 database (to provide clues to partially identify financial information). These partial financial identifications are like partial license plate identification.

In another aspect, system 100 assigns one or more lists of transaction types into necessities and non-necessities classifications. In one embodiment, a portion of purchases may be general categorical and/or vague, for instance, in accordance with store identity, e.g., Wal-Mart, where debtor purchases needed items (necessities) and wanted items (non-necessities). In other instances, another portion of a purchase may be classified by one or more unique business classifications or categories: such as furniture, salon, boat rental, and scuba dive. In addition, purchases may be graded as non-dischargeable items and subject to a higher level of scrutiny. As a number of purchases or transactions are assessed and scrutinized, the stronger the case becomes. During analysis, system 100 will provide objective indicators that will provide inputs as to worth of case (e.g., provide objective evidence as to if the case is worth pursuing).

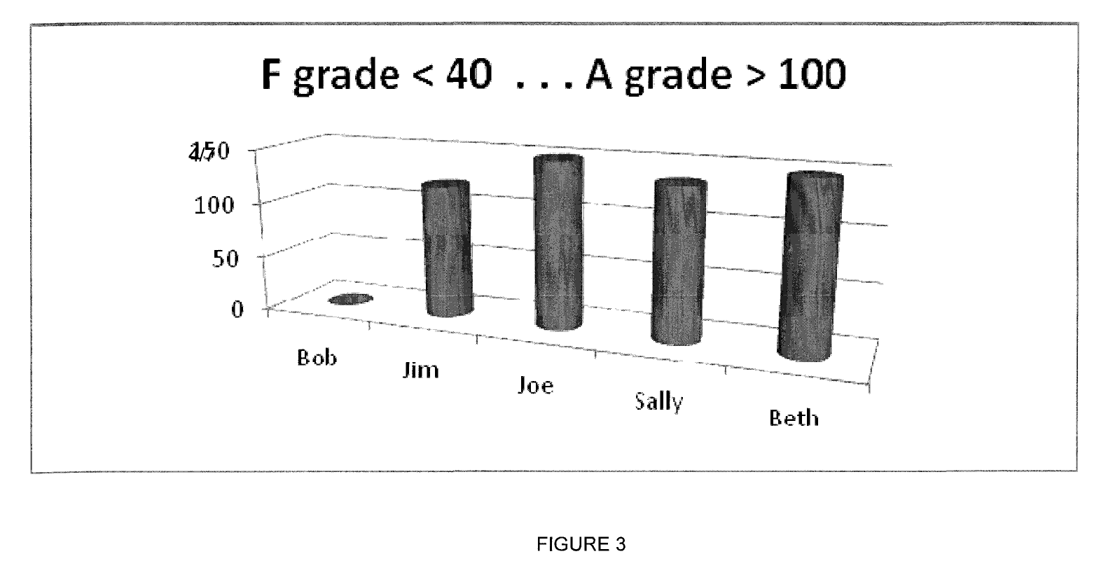

Referring to FIG. 3, system 100 outputs paperwork, including objective evidence of non-dischargeability of one or more item set(s) that may be sent to debtor's attorney for settlement purposes based on debt grading criteria. The debt grading criteria will assist in matching one or more financial line transactions with a grade level (e.g., A-E). In one variant, grade “A” (high probability of recovery) item may be deemed a non-dischargeable item (desired item) as opposed to a “needed item”. In one example, grade “A” item may be an unusual or uncharacteristic purchase such as a furniture set from “Furniture Plus”. In yet another variant, grade “E” (low probably of recovery) items may account for a short frequency and result in a large credit card balance; however, this may be a more routine purchase and the items deemed non-dischargeable (needed items). For instance, $500.00 purchase (a large credit card balance) for grocery items including milk, cereal, hamburger, hot dogs, rice, and lettuce are basic items needed for daily consumption and portions/quantity of this purchase reasonable based on number of individuals in a household. On the other hand, financial line transactions for large ticket purchase times (e.g., over $5,000.00) and purchased shortly before filing or requesting debt relief in bankruptcy (e.g., 30 days before filing a bankruptcy case) may be singled out and pursued regardless of any assigned grading or rating criteria. For instance, these large ticket purchase and purchases shortly before filing for bankruptcy relief, for instance, have a high correlation of being a portion of one or more likely non-dischargeable items (e.g., fraudulent transactions: transactions that debtor never intended to pay back at the time of purchase).

In another aspect, system 100 reviews and computes a disputed amount derived during a time window ending with chapter 7 bankruptcy filing date and looking backwards in time until a disputed amount reaches its highest value (e.g., peak). The disputed amount is graded in accordance with rating (A-F) to determine initial down payments as well as monthly payments for payback of the credit card balance. In one variant, the time window will not include frequent payments or large payment amounts there within (the time window) to increase rating for collectability. For, if system 100 detects a few payment amounts followed by a high cash advance amount (e.g., greater than $1200.00), then the system will ignore the few payment amounts so that this scenario qualifies for grade level A (high probably of recovery) and a winnable case in court. As a result, due to the high grade level (A), this type of case will most likely be able to settle out of court with simply a collection letter to the debtor.

In another embodiment, once grading or rating has been issued for all financial line transactions, grading or rating of multiple financial line transactions are, for instance, averaged or weighted with other factors and pertinent date(s) of relevancies. In one variant, a maximum disputed amount generated is weighted on a per transaction basis by an aging criterion to provide more real-time indication of a consumer's readiness to accept a higher financial credit line or make payments on an outstanding credit card invoice. In another variant, dynamic information from diverse rankings or overlay logic may be combined within the weighting function(s) or dynamic function amount scaling. In another variant, a historical date slider locates and determines a cutoff date to determine a transaction range (e.g., a reporting period) for presentation to a debtor's representative, attorney, legal body, and a court. In yet another variant, linear comparison sub-tables (e.g., payment scales or ratios over purchases and case advances) are utilized to process further the financial transactions. In yet another variant, a proposed amount qualifier may be utilized to determine a date range of suspected recoverable transactions (e.g., fraudulent transactions). In one example, after assigning a grade and new disputed amount, system 100 will generate a recommended payment amount and payment plan for a debtor to pay back a specified percentage of a disputed amount based on the grade level.

### Transaction Scoring

Consumer financial transactions are scored and graded. In one variant, specific performance requirements relevant to Critical-To-Quality (CTQ) characteristics are mapped including identified inputs and outputs.

Below are formulas used in scoring and grading credit ratings of consumers in accordance with weighting and bankruptcy association rules.

Referring to FIG. 4, frequent item sets are utilized to form a lattice. In the lattice, various letter groups or supplemental information in a box indicate how many transactions contain the combination of one or more items. In one example, lower levels of lattice include a minimum number of purchased items to satisfy one or more post-bankruptcy associative elements 116 criteria. Lattice applies post-bankruptcy association rules 125 required to satisfy specified support and confidence level 142. Lattice is categorized or arranged into item sets, from bottom to top, in a direction of increasing frequency of transactions, credit card balance, and/or transaction value in accordance with bankruptcy associative elements including frequency of payments 118, level of payment 120, uncharacteristic purchase 121, types of charges 122, and frequency of charges 123.

### Post Bankruptcy Association Rule Generation

Post bankruptcy association rule generation occurs in steps of: minimum support level being applied to find frequent item sets in a database, and frequent item sets and the minimum confidence constraint used to form post bankruptcy association rules 125.

Below is an association rule algorithm applied to consumer financial transactions:

conf(X [symbol] Y)=supp(X∪Y)/supp(X) D={t₁,t₂, . . . ,tₘ}

In a generated bankruptcy association rule set, X and Y refer respectively to an array of first and second set of consumer transactions 104, 106. The rule X=>Y holds record set D database with confidence (conf). In this example, D record set has line item transactions t at times (t₁, t₂ . . . tₘ) (e.g., specified period) that form D database. Each transaction in D database has a unique transaction ID and contains a subset of one or more item set(s) of bankruptcy association rules 125.

Within D database, each of the one or more item sets(s) are individually examined for spending patterns in accordance with: frequency of payment 118 (e.g., transaction balance(s) for each line item), level of payment 120 (e.g., uncharacteristic purchase 121, transaction payment(s), debtor court case indicators, types of charges 122 (e.g., transaction purchases, cash-transfer, cash advances), and frequency of charges 123.

### Non-Unique Transactions

If confidence (conf) 142 of records in D that has support (sup) 143 X also has support (sup) 143 Y, the rule X=>Y has support s 143 in the record set. In this case, s percentage (%) of records in D support (supp) X U Y (union of X and Y). The support (supp) 143 (X) of an item set contained in X U Y is defined as the proportion of transactions contained in a data set for a specified period that contain one or more item sets. For example, item set may be assigned a support value of ⅛=0.125 because it occurs in 12.5% of all transactions t (t₁, t₂ . . . tₘ) (1 out of 8 transactions) during a specified period in X.

### Unique Transactions

If one or more t transactions contained in X are unrelated to prior purchases conditions A and B of Y, then the bankruptcy association rules learn and create an association with prior purchase conditions A and B by determining relatedness or association with prior purchases:

strength(A&X→B)≈strength(A→B)

lift(A&X→B)≈lift(A→B)

### Aging Transactions

Unique transactions (uncharacteristic purchase 121) are measured against aging, (changed in relevance) in accordance to any or all the following factors: similarity to prior (pre) and post purchases of that item, a severity rating based on type (which may be based on SIC code relevance) to generate debt grading criteria 128.

Below gradient function creates a scalar representation of transaction A to adjust or move relevance (x) of a transaction A in reference to age (f) of transaction in accordance with debt grading criteria 128:

∇(f(Ax))=(A)^{T}(∇f)(Ax))=(A)⁻¹(∇f)(Ax))

### Capture Recovery Amount

The above equations assist in identifying and capturing a recoverable case amount for settlement purposes or for court recovery that has objective evidence for collectability.

$$f ( x ) \approx f ( {x}_{0} ) + {( ∇ f )}_{{x}_{0}} \cdot ( x - {x}_{0} )$$

$$∇ f = ( \frac{\partial f}{\partial {x}_{1}} , … , \frac{\partial f}{\partial {x}_{n}} ) .$$

### Gradient Theorem

Using the above equations: a vector associate representation is created for scalar values included as part of a transaction (f(x)) characterized by post bankruptcy associative elements 116 of one or more item set(s) to identify a direction of increase or decrease in spending or payback of credit, where:

f(xo) represents an average purchase transaction amount for a line item

f(x) represents a real-time purchase transaction amount for a line item

x1 . . . xn represents multiple transactions per item set

∇f represents a scalar representation of a rate of change Δ (delta) of real-time purchase transaction amount per line for x₁ to xₙ transactions

f(xo) represents an average transaction amount per item set

$$\frac{\partial ( {f}_{1} , {f}_{2} … {f}_{n} )}{\partial ( {x}_{1} , {x}_{2} … {x}_{n} )}$$

### Jacobian Matrix

Using the above equation, each line-transaction of system 100 is represented in an n×n matrix of first-order partial derivatives of the functions f₁, f2, f₃ relative to x₁, x2, and x3 to establish a direction of a rate of change (decrease or increase) in a spending or payback pattern for a consumer for multiple line item transactions.

$${\sum }_{j = 1}^{n} {X}^{j} ( ϕ ( x ) ) \frac{\partial }{\partial {x}_{j}} ( f \cdot {ϕ}^{- 1} ) {\vert}_{ϕ ( x )} ;$$

### Riemannian Manifolds

Using the above equation, a real differentiable manifold is created for matrix X of line item transactions x in which each tangent space is equipped with an inner product, e.g., Riemannian metric, to provide smoothing functionality between points of each unique line item transactions x and item sets associated with post bankruptcy associative rules 125.

### Example of System 100 Operation

In operation, system 100 compares line items transactions from a first period with those of another period in accordance with post bankruptcy associative elements 116 to create post bankruptcy associative rules 125. Frequent line item transactions and unusual line item transactions are marked for further characterization and association with post bankruptcy associative elements by system 100. In accordance with computations discussed above, e.g., unique transactions, non-unique transactions, and aging, are utilized to create a disputed amount being derived from a summation of transactions t at times (t₁ . . . tₙ) within a specified period. For example, a summation of f(x−x₀) is created including line item transactions, purchases, cash advances, balance transfers minus payments within a specified period (e.g., a given date range). Initially, transactions t at times (t₁ . . . tₙ) are chosen from a fixed start date to any negative (prior) date using system 100. In one variant, payment frequency and amount ratios are factored within this calculation. In another variant, the specified period may be a variable date range that includes start and end dates chosen by system 100 to locate uncharacteristic transactions or high frequency of related or unrelated transactions in a specific period in accordance with post bankruptcy associative elements 116.

In the above exemplary embodiments, system 100 processes consumer financial transactions and matches, automatically or semi-automatically, post bankruptcy elemental categories with those of appropriate rules of governmental regulatory agencies, e.g., local and US bankruptcy codes and regulations. As such, system 100 determines if a match results between spending associated with one or more database entries (e.g., non-dischargeable, dischargeable, fraud elemental categories). In yet another variant, system 100 automatically determines if a match results to US government exceptions to discharge of debt, for instance, Bankruptcy Code 11 U.S.C. Section 523.

In yet another embodiment, fraud elemental categories are matched against those for exceptions to discharge of debt associated with local bankruptcy laws. For instance, the local bankruptcy laws of a consumer's current residence state or prior residence state are automatically or semi-automatically utilized to decipher, categorize, and record objective fraud evidence for creditor collection department or collection agency utilization. Advantageously as compared to conventional credit card company generated credit reports, system 100 report provides persuasive information to convince a consumer account holder (even before court case) or at the court case that these consumer debts must be paid and are not the type for discharge by a court. In one instance, system 100 generates a proposed settlement letter including case details as well as reasons for this settlement. In one example, proposed settlement letter includes a summation of transaction amounts and types, snapshot of disputed calculation, and transaction history date range.

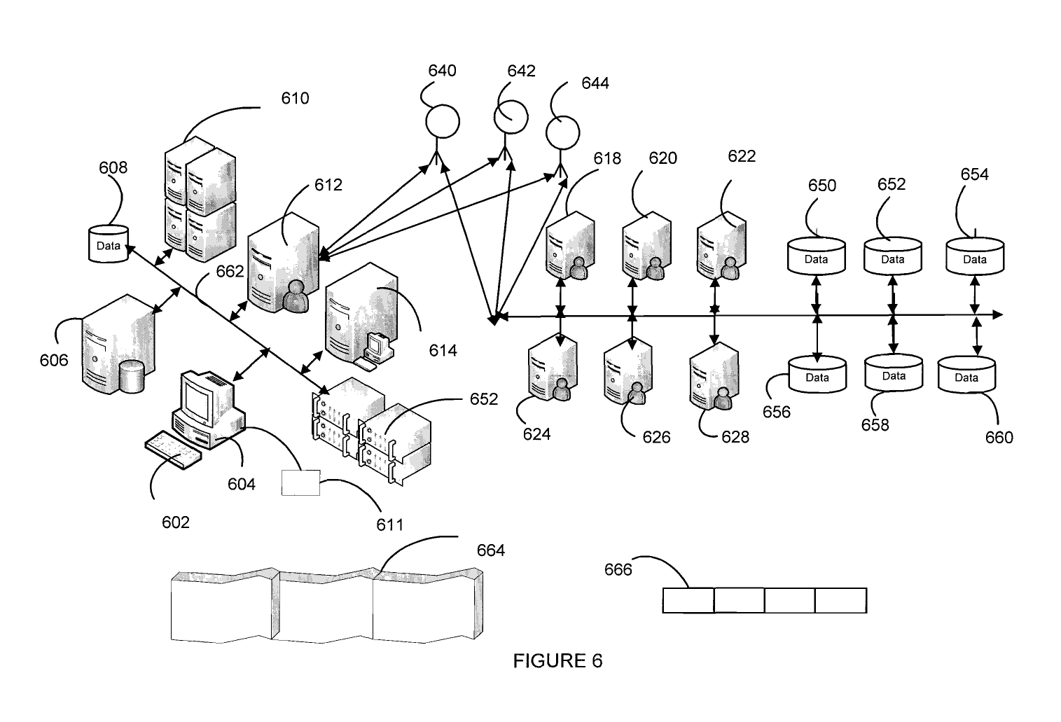

Referring to FIG. 6, system 600 communicates, for instance, using communications server 612 by wired or wireless means with banks, lenders, public databases extracting data utilizing consumer pre-bankruptcy detection algorithm of FIG. 1. System 600 includes data storage hardware devices 608, 610 capable of storage of first and second set of consumer transaction data 106, 104, first and second sets of association data 112, 114, as well as other components including pre-bankruptcy associative elements 116 on a temporary or permanent basis. Application server 606 stores program code, for example, pre-bankruptcy association rule algorithm 102 stored in a semi-transitory or non-transitory software media capable of transferability using communications server 612 to transmit wired or wirelessly from processor unit 611, for example, communicatively coupled to computer 604 that has a keyboard 602 to allow a user to provide input thereto.

Continuing with this embodiment, system 100 may store program code in application server 606 in one or more tangible forms, for example, in a communicatively coupled to memory 664 (which may be ram, flash, or flash drive) or persistent storage 608 such as a hard drive or rewritable hard-disk external (that may be fixed or removable) communicatively coupled to computer 604, for instance, bus line, e.g., bus line 662.

In one embodiment, communications server 612 transmits wirelessly to another network, e.g., radio towers, cell-phone towers, communication satellites, or the like 640, 642, 644, to access private documents 140 (see FIG. 1) stored in one or more databases 650, 652, and 654 (e.g., private databases). In one variant, the one or more databases 650, 652, and 654 are one or more lending institutions accessible through communication servers 618, 620, and 622 coupled wirelessly, e.g., using communication satellites 640, 642, 644, or wired, for instance, to bus line, e.g., bus line 651. In another variant, communications server 612 transmits wirelessly to another network, e.g., radio towers, cell-phone towers, communication satellites, or the like 640, 642, 644, to access public documents 126 stored in one or more databases 656, 658, and 660 (e.g., court databases) that are, for instance, accessible through bus line, e.g., bus line 651. In yet another example, system 100 may be stored in memory in a consumer apparatus or product 666 (e.g., a hand-held computer with plug in serial, parallel, or usb adaptor compatibility) directly through bus line 651 or wirelessly using cell phone towers, communication satellites 640, 642, 644 to access, for instance, one or more databases 650, 652, 654, 656, 658, 660 for accessing first or second set of consumer transaction data 106, 104 for processing by system 100.

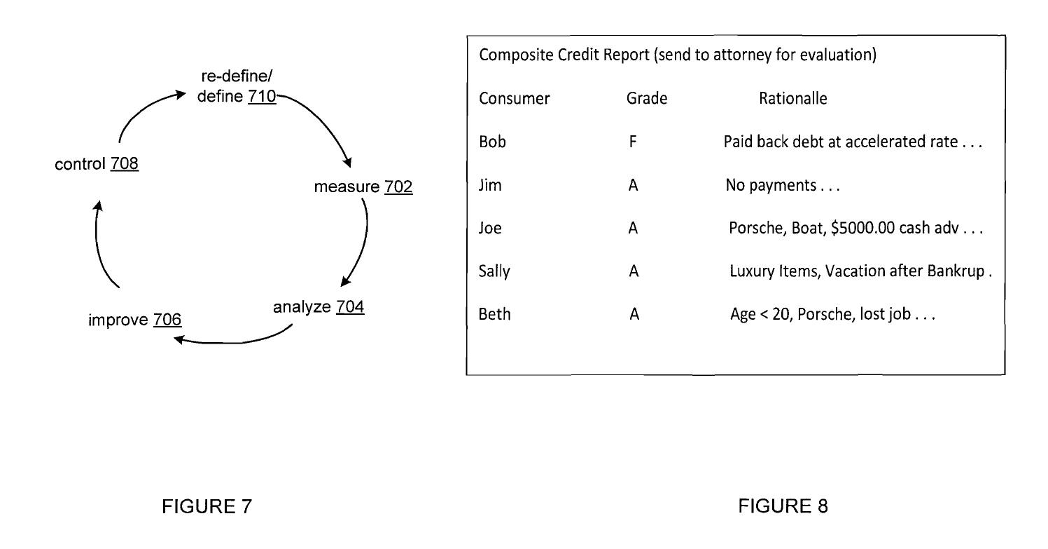

Referring to FIG. 7, relevant outputs and potential inputs suspected to impact each other are connected. System 100 generates one or more lists of potential measurements (post-bankruptcy associative elements 125, post bankruptcy association learning rule algorithm 124, post bankruptcy association rule algorithm 102) that are analyzed against first or second set of association data 112, 114 (e.g., data sets) to establish financial baseline 144. During processing of financial baseline 144, measurement errors are identified (e.g., algorithms discussed above determine related item sets or need to create additional item sets or associations). During start of input measurements, system 100 collects and processes outputs and data (e.g., consumer transactions are evaluated). During a validation phase, there is an indication that a problem exists (e.g., unusual, unique, repeat and/or consecutive transactions are analyzed). Based on measurements, e.g., measure 702, specifics of a problem may be used to re-define/define 710 and/or change an objective, e.g., analyze 704. As such, system 100 electronically filters and traps data that contain erroneous or subjective conclusions. For instance, system 100 may do any or all the following: eliminate distracting data, choose another starting point 110 to maximize recovery amount or improve, e.g., improve 706, scorecard value, recalculate debt by removing one of multiple credit cards from calculation to meet minimal dollar collection value requirements. In another instance, system 100 may reconcile non-misleading data patterns (control 708 by removing or avoiding payment history, which prevents credit card balance recovery) and storing key points thereof.

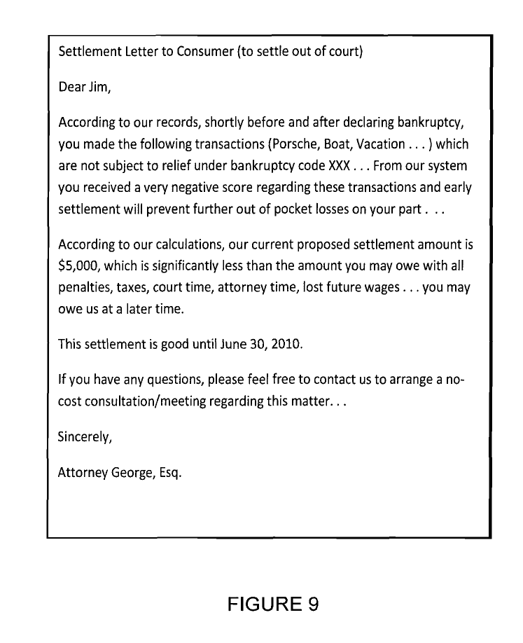

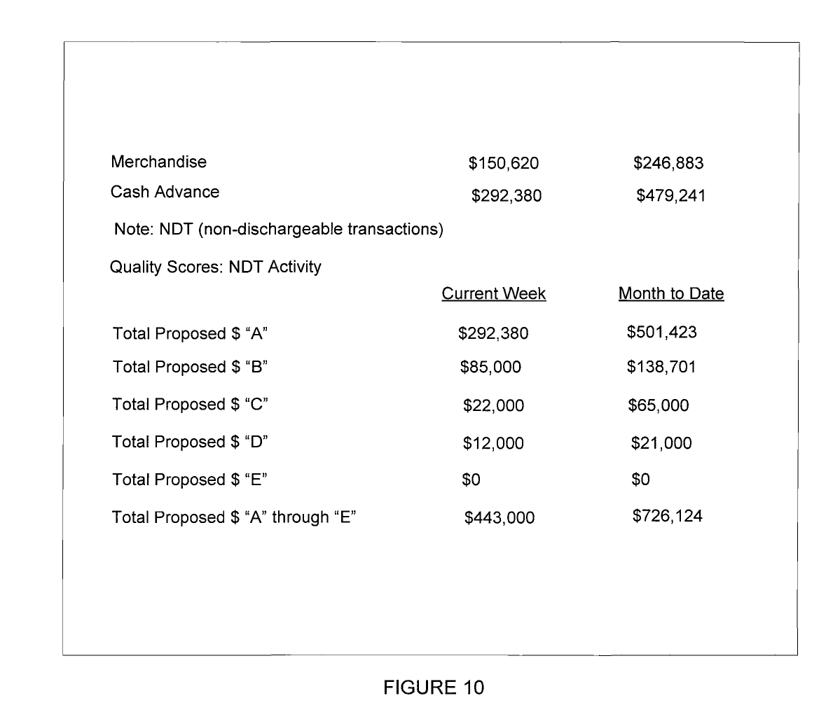

Referring to FIG. 8, a summary of all financial transactions processed (e.g., outcome report) of a collection of consumer debt cases. Referring to FIG. 9, a proposed settlement amount is automatically or semi-automatically generated for a chosen consumer. Referring to FIG. 10, “A” grade case is deemed winnable and “E” grade cases are deemed unwinnable. For “P” Prose (debtor represents themselves), these cases are handled differently and, for example, may not be processed. Referring to FIG. 10, there is a summary report for a credit card provider that generates and outputs merchandise and cash advances based on non-dischargeable transactions. In addition, this summary report provides weekly and monthly status per grading process (A-F). The report generated illustrates non-dischargeable transactions that may be recoverable in a convenient weekly and monthly table in accordance with debt grading criteria 128 and post-bankruptcy associative elements 116 illustrated in FIG. 1.

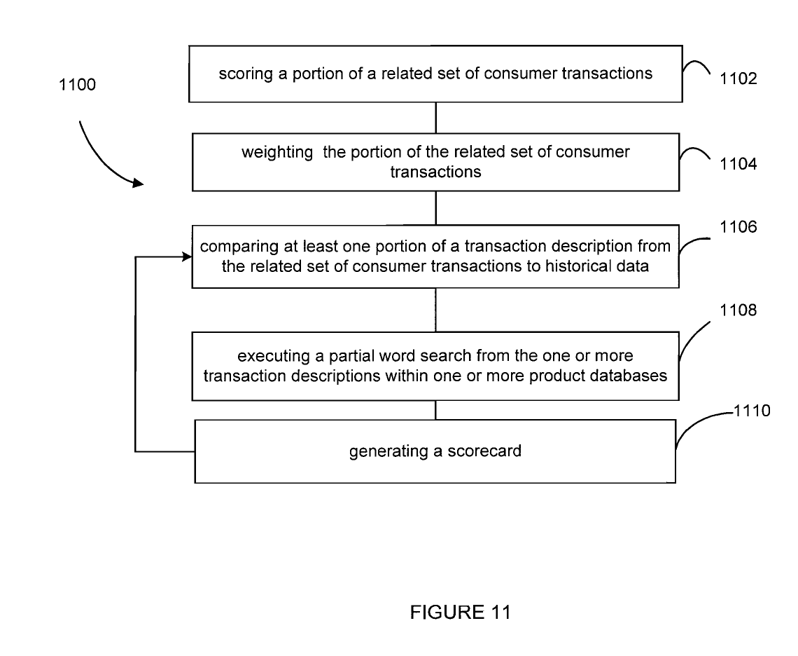

Referring to flowchart 1100 of FIG. 11, a method is disclosed for post-bankruptcy recovery of an outstanding credit card balance. In step 1102, a portion of a related set of consumer transactions and received payments is scored in accordance with item set criteria to determine a level of collectability. In one variant, the portion of the related set of consumer transactions includes a set of consumer transactions having an uncharacteristic spending pattern within a specified period that has not been paid back. In one variant, the uncharacteristic purchase includes at least one of a cash advance or purchase greater than $500.00. In one variant, the related set of consumer items comprises at least one item set selection of purchases of services or products categorized in accordance with gaming, gambling, or casino services within a specified period before the consumer files of bankruptcy.

In another variant of step 1102, the related set of consumer items comprises at least one item set selection of purchases of services or products categorized in accordance with high end-hotels, car repairs, airline tickets, entertainment events, vacation packages, high end clothing stores, jewelry, and high end electronics within a specified period before the consumer files bankruptcy. In yet another variant of step 1102, weighting the portion of the related set of consumer transactions in accordance with age of data includes evaluating at first item set individually in accordance with a debt grading criteria (e.g., age grading criteria). The debt grading criteria (e.g. age grading criteria) based on historical frequency of purchase of a service or product that indicates an uncharacteristic high credit card balance or a period when payback of an existing credit card balance is at a minimum payment level or less than 5% of the existing credit card balance.

In step 1104, the portion of the related set of consumer transactions is weighted in accordance with age of data and in accordance with external consultant assessments and recommendations based on consumer financial status. In step 1106, at least one portion of a transaction description from the related set of consumer transactions is compared to historical data from transaction descriptions to update and adjust a level of collectability.

In step 1108, partial word search is executed from the one or more transaction descriptions with one or more product databases to at least partially identify if a product or service from the set of consumer transactions has an associated necessity or a non-necessity purpose to adjust the level of collectability.

In step 1110, a ratio is generated of the associated necessity to non-necessity purpose to further adjust the level of collectability. In one variant of step 1110, debt scorecard is generated that indicates an amount qualifier that interrelates to the level of collectability of the outstanding credit card balance.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description includes the best mode presently contemplated of carrying out the invention. This description is in no way meant to be limiting, but rather should be taken as illustrative of the general principles of the invention.

What is claimed is:

1. A method for post bankruptcy recovery of a consumer with an outstanding credit card balance comprising:
scoring a portion of a related set of consumer transactions and received payments in accordance with an item set criteria to determine a level of collectability;
weighting the portion of the related set of consumer transactions in accordance with age of data and in accordance with external consultant assessments and recommendations based on consumer financial status;
comparing at least one portion of a transaction description from the related set of consumer transactions to historical data from transaction descriptions to update and adjust the level of collectability.

2. The method of claim 1, further comprising the step of:
executing partial word search from one or more transaction descriptions with one or more product databases to at least partially identify if a product or service from the related set of consumer transactions has an associated necessity or a non-necessity purpose to adjust the level of collectability.

3. The method of claim 2, further comprising the step of:
generating a ratio of the associated necessity to the non-necessity purpose of the consumer credit card balance to further adjust the level of collectability.

4. The method of claim 3, further comprising the step of:
generating a debt scorecard that indicates an amount qualifier that interrelates to the level of collectability of the outstanding credit card balance.

5. The method of claim 1, wherein the portion of the related set of consumer transactions comprises a set of consumer transactions each having a uncharacteristic purchase or spending pattern within a specified period that has not been paid back.

6. The method of claim 5, wherein the uncharacteristic purchase includes at least one of a cash advance or purchase greater than $500.00.

7. The method of claim 1, wherein the related set of consumer transactions comprises at least one item set selection of purchases of services or products categorized in accordance with gaming, gambling, or casino services within a specified period before the consumer files for a discharge of debts under bankruptcy.

8. The method of claim 1, wherein the related set of consumer items comprises at least one item set selection of purchases of services or products categorized in accordance with high end-hotels, car repairs, airline tickets, entertainment events, vacation packages, high end clothing stores, jewelry, and high end electronics within a specified period before the consumer files for a discharge of debts under bankruptcy.

9. The method of claim 1, wherein weighting the portion of the related set of consumer transactions in accordance with age of data comprises evaluating a first item set individually in accordance with a time grading criteria based on historical frequency of purchase of a service or product that indicates an uncharacteristic high credit card balance or a period when payback of an existing credit card balance is at a minimum payment level or less than 5% of the existing credit card balance.

10. A system for post bankruptcy recovery of a consumer with an outstanding credit card balance comprising:
a scoring module operable to score a portion of a related set of consumer transactions and received payments in accordance with an item set criteria to determine a level of collectability, the related set of consumer transactions comprises at least one item set selection of purchases of services or products categorized in accordance with high end-hotels, car repairs, airline tickets, entertainment events, vacation packages, high end clothing stores, jewelry, and high end electronics within a specified period before consumer files for debt relief under bankruptcy;
a weighting module operable to weight the portion of the related set of consumer transactions in accordance with age of data and in accordance with external consultant assessments and recommendations based on consumer financial status; and
a comparison module operable to compare at least one portion of a transaction description from the related set of consumer transactions to historical data from transaction descriptions to update and adjust the level of collectability, the historical data being chosen in accordance indicate at least one of a poor credit card payment history or high credit card balance with payments of a minimum credit card payment.

11. The system of claim 10, wherein the comparison module is further operable to generate a ratio of an associated necessity to a non-necessity purpose to further adjust the level of collectability.

12. The system of claim 10, further comprising a debt scorecard module operable to generate a debt scorecard that indicates an amount qualifier that interrelates to the level of collectability of the outstanding credit card balance.

13. The system of claim 10, wherein the portion of the related set of consumer transactions comprises a set of consumer transactions each having a uncharacteristic spending pattern within a specified time period that has not been paid back.

14. The system of claim 10, wherein the uncharacteristic purchase includes at least one of a cash advance or purchase greater than $500.00.

15. The system of claim 10, wherein the related set of consumer items comprises at least one item set selection of purchases of services or products categorized in accordance with gaming, gambling, or casino services within a specified period before the consumer files for a discharge of debts under bankruptcy.

16. A method for assistance in generation of objective evidence of an outstanding credit card balance in a post-bankruptcy setting, the method comprising:
scoring a portion of a related set of consumer transactions and received payments by credit card company in accordance with an item set criteria to determine a level of collectability;
weighting the portion of the related set of consumer transactions in accordance with age of data and in accordance with external consultant assessments and recommendations based on consumer financial status; wherein a first item set is evaluated individually in accordance with a time grading criteria based on historical frequency of purchase of a service or product that indicates an uncharacteristic high credit card balance or a period when payback of an existing credit card balance at a minimum payment level or less than 5% of the existing credit card balance;
comparing at least one portion of a transaction description from the related set of consumer transactions to historical data from transaction descriptions to update and adjust the level of collectability; and
executing partial word search from the one or more transaction descriptions with one or more product databases to at least partially identify if a product or service from the set of consumer transactions has an associated necessity or non-necessity purpose to adjust the level of collectability.

17. The method of claim 1, further comprising the step of generating a ratio of the associated necessity to non-necessity purpose to further adjust the level of collectability.
